(19) United States
(12) Patent Application Publication
(10) Pub. No.: US 2024/0343994 A1
(43) Pub. Date: Oct. 17, 2024

(54) MULTI-PART REFILLABLE CANDLE PRODUCT

(71) Applicant: Benjamin LoBue, Spokane, WA (US)

(72) Inventor: Benjamin LoBue, Spokane, WA (US)

(21) Appl. No.: 18/610,877

(22) Filed: Mar. 20, 2024

Related U.S. Application Data
(60) Provisional application No. 63/453,565, filed on Mar. 21, 2023.

(51) Int. Cl. C11C 5/00

(52) U.S. Cl. CPC C11C 5/008

(57) ABSTRACT

A multi-part refillable candle container product may utilize a two-piece exterior container, made of premium rigid materials such as wood and concrete, allowing users to easily replace or swap out candles without sacrificing premium decorative appearance. The two-piece exterior container may include mechanical features constructed and arranged to attach the two-piece exterior container together.

### CROSS-REFERENCE TO RELATED APPLICATIONS

The present application claims priority to U.S. Provisional Application No. 63/453,565 filed Mar. 21, 2023, titled “MULTI-PART REFILLABLE CANDLE PRODUCT,” which is hereby incorporated by reference in its entirety.

### TECHNICAL FIELD

The embodiments disclosed herein generally relate to an apparatus for replaceable or refillable candles.

### BACKGROUND

Candles include an ignitable wick embedded in wax, or other flammable solid substance which provides light, and in some cases, a fragrance. Various devices have been created to hold the candle throughout its use and storage. During production, candle wax may be poured into a vessel or container and take the shape thereof. Decorative candle holders are common and also provide the function of containing the flammable substance and prevent the substance from dripping onto other surfaces. After use of the candle, the containers are often wastefully discarded.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments provided herein relate to an open-top multi-part container product including a two-part exterior container comprising a bowl portion and a lip portion, wherein the bowl portion defines a bowl portion cavity and at least one recess, and wherein the lip portion is constructed and arranged to mechanically mate with the recess within the bowl portion; and a replaceable or refillable interior container positionable within the bowl portion cavity. A wax candle, or wax and wick combination, may be within the replaceable interior container.

In one aspect, the bowl portion and the lip portion lockingly engage via a mechanical connection.

In one aspect, the mechanical connection includes a protrusion and a receiving recess, a tongue and groove, a pair of concentric mating lips, or a pair of complimentary divot portions and raised portions.

In one aspect, the two-part exterior container is constructed of at least one of the following: wood, metal, ceramic, and concrete. The material may be a heat-tolerant rigid material.

In one aspect, the bowl portion defines a through-hole in a bottom of the bowl portion.

In one aspect, a bowl-shaped vessel constructed and arranged to seat within the bowl portion.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a perspective view of the open-top multi-part candle container, according to some embodiments; and

FIG. 2 illustrates perspective view of the open-top multi-part candle container, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to an open-top multi-part candle container which may utilize a two-piece exterior container, made of premium rigid materials such as wood, metal, ceramic, or concrete, allowing users to easily replace or swap out candles without sacrificing premium decorative appearance. The disclosed open-top multi-part candle container may include an interlocking design between the top and bottom portions of the exterior container joinable via optional magnets to further hold together the top and bottom. The disclosed multi-part refillable candle provides added safety, while utilizing 100% recyclable aluminum for the consumable candles to reduce environmental impact and waste associated with traditional candle containers. The disclosed multi-part candle container also includes a replaceable interior container to provide cost savings for consumers over alternative luxury candles.

The disclosed open-top multi-part candle container may include a two-part exterior container and a replaceable interior container.

The open-top two-part exterior container may be generally bowl shaped, however, other decorative arrangements and shapes are considered included within this disclosure. The two-part exterior container may include a bowl portion and a lip portion which may lockingly engage with one another via a mechanical connection, such as a projection and receiving recess or similar complimentary mechanically engaging connection. The mechanical connection may include a variety of complimentary, mating, mechanical connection profiles including, but not limited to, tongue and groove, complimentary divots and raised portions, concentric mating lips, or similar. The bowl portion may define a through hole in the bottom. A plurality of magnets may be disposed within the bowl portion and lip portion to facilitate magnetic connection of the two. The two-part exterior container may be constructed of heat-tolerant rigid materials such as, but not limited to, wood, concrete, cork, ceramic, marble, metal, or the like. According to some embodiments, the lip portion and bowl portion may be made of different rigid materials, such that lip portions and bowl portions may be interchanged to achieve a desired aesthetic.

The replaceable interior container may be a generally bowl-shaped vessel constructed and arranged to seat within the bowl portion of the two-part exterior. The lip portion of the two-part exterior may then be seated over the interior container and bowl portion of the two-part exterior to lock the position of the interior container within the two-part exterior. The lip portion may define an opening therein to expose a replaceable interior container seated within the bowl portion. The replaceable interior container may include a wick and wax body therein for use as a candle of varying scents, wax varieties, formulations, or the like. In this way, the replaceable interior container may contain a replaceable candle seated within the bowl portion and locked in position via attachment of the lip portion, while leaving the wick and wax body exposed to the atmosphere.

According to some embodiments, the wick and wax body may form a replaceable candle that may be easily replaced within the replaceable interior container.

In this way, the two-part exterior may lockingly hold the replaceable interior container within, and a replaceable candle refill cartridge may be seated within the replaceable interior container to provide an easily separable two-piece exterior container allowing for the replacement of candle refill cartridges.

The embedded magnets in the exterior container combined with a designed interlocking curvature between the bowl portion and lip portion allow users to twist and separate the container to open it easily. The replaceable interior container may be easily removed, aided by the hole in the bottom of the exterior container to push it out with a finger, and replaced with a new candle or alternative scent.

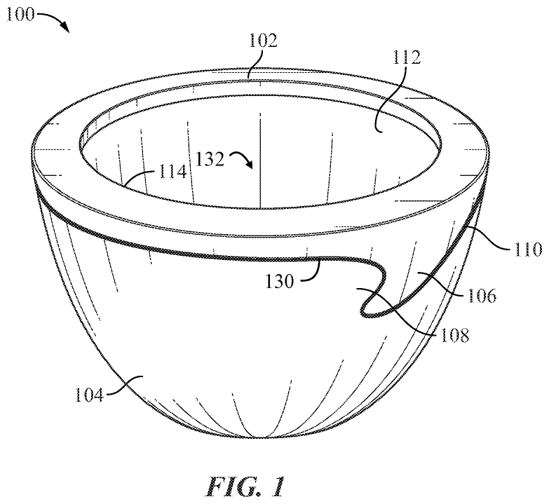

Referring to FIG. 1, an open-top multi-part refillable candle container 100 may include a two-part exterior container 102, 104 and a replaceable interior container 112. The two-part exterior container 100 may include a bowl portion 104 and a lip portion 102 which may lockingly engage with one another, via a mechanical connection such as a projection 106 and recess 108 connection, forming a seam 110 therebetween. An interior container 112 defining a bowl cavity 114 therein may be seated within the two-part exterior container 102, 104.

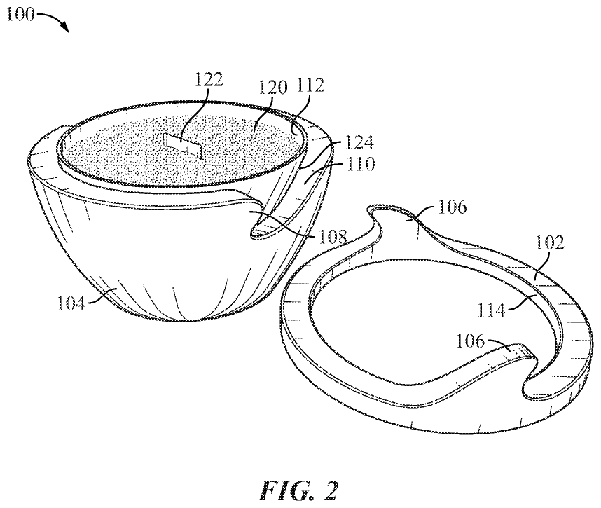

Referring to FIG. 2, a multi-part refillable candle container 100 may include a two-part exterior container 102, 104 and a replaceable interior container 112. The two-part exterior container 102, 104 may include an opening defined at least partially by the lip portion 102 to expose a replaceable interior container 112 seated within the bowl portion 104.

The two-part exterior container 100 may include a bowl portion 104 and a lip portion 102 which may lockingly engage with one another via a plurality of projections 106 and recesses 108, forming a seam 110 therebetween.

An interior container 112 defining a bowl cavity 114 therein may be seated within the two-part exterior container 102, 104. The interior container 112 may include a candle therein including a wick 122 and wax body 120. The replaceable interior container 112 may be seated within a bowl portion cavity 124 defined by the bowl portion 104.

The open-top lip portion 102 may define a through hole 132 to be seated over the replaceable interior container 112.

In some embodiments, the various components described hereinabove may be constructed of reusable materials such that the container 100 is reusable. The materials used may be heat-resistant such as to withstand exposure to high heat during combustion of the candle. In such, the device provides for an environmentally friendly means of displaying a candle.

In some embodiments, the various components or a subset of the various components may be constructed of a disposable material. In particular, the replaceable interior container 112 may be constructed of a single-use material, such that once the candle is done being burned, the replaceable interior container 112 may be disposed of.

In some embodiments, the various components may be sold as a set or a kit such that the device is interchangeable between elements. This allows the user to fully customize the aesthetic appearance of the device. This may be especially useful for users who wish to change the aesthetic decorations of the device.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. An open-top multi-part container product for a candle, comprising:
a two-part exterior container comprising a bowl portion and a lip portion, wherein the bowl portion includes a bowl portion cavity and at least one recess, and wherein the lip portion defines a center opening and comprises at least one projection constructed and arranged to mechanically mate with at least one recess; and
a replaceable interior container positionable within the bowl portion cavity.

2. The apparatus of claim 1, wherein the bowl portion and the lip portion lockingly engage via a mechanical connection.

3. The apparatus of claim 2, wherein the mechanical connection includes a protrusion and a receiving recess.

4. The apparatus of claim 2, wherein the mechanical connection is a tongue and groove connection.

5. The apparatus of claim 2, wherein the mechanical connection is a pair of concentric mating lips.

6. The apparatus of claim 2, wherein the mechanical connection is a pair of complimentary divot portions and raised portions.

7. The apparatus of claim 1, wherein the two-part exterior container is constructed of at least one of the following: wood, metal, ceramic, and concrete.

8. The apparatus of claim 1, wherein the two-part exterior container is constructed of a heat-tolerant rigid material.

9. The apparatus of claim 1, wherein the bowl portion defines a through-hole in a bottom of the bowl portion.

10. The apparatus of claim 1, wherein a bowl-shaped vessel is constructed and arranged to seat within the bowl portion.

11. An open-top multi-part container product for a candle, comprising:
a two-part exterior container comprising a bowl portion and a lip portion, wherein the bowl portion includes a bowl portion cavity and at least one recess, and wherein the lip portion defines a center opening, wherein the bowl portion and the lip portion magnetically engage to form a reservoir for a flammable material; and
a replaceable interior container positionable within the bowl portion cavity,
the flammable material comprising a wax body and a wick.

12. The apparatus of claim 11, wherein the bowl portion and the lip portion lockingly engage via a mechanical connection, wherein the mechanical connection defined by the connection between a plurality of projections and a plurality of recesses, wherein the plurality of projections and the plurality of recesses form a seam therebetween.

13. The apparatus of claim 12, wherein the mechanical connection includes a protrusion and a receiving recess.

14. The apparatus of claim 12, wherein the mechanical connection is a tongue and groove connection.

15. The apparatus of claim 12, wherein the mechanical connection is a pair of concentric mating lips.

16. The apparatus of claim 12, wherein the mechanical connection is a pair of complimentary divot portions and raised portions.

17. The apparatus of claim 11, wherein the two-part exterior container is constructed of at least one of the following: wood, metal, ceramic, and concrete.

18. The apparatus of claim 11, wherein the two-part exterior container is constructed of a heat-tolerant rigid material.

19. The apparatus of claim 11, wherein the bowl portion defines a through-hole in a bottom of the bowl portion.

20. The apparatus of claim 11, wherein a bowl-shaped vessel constructed and arranged to seat within the bowl portion.
